(19) United States
(12) Patent Application Publication
(10) Pub. No.: US 2012/0112576 A1
(43) Pub. Date: May 10, 2012

(54) INVERTER FOR AN ELECTRIC MACHINE

(75) Inventors: Bradley D. Chamberlin, Pendleton, IN (US); Alex Creviston, Muncie, IN (US)

(73) Assignee: REMY TECHNOLOGIES, L.L.C., Pendleton, IN (US)

(21) Appl. No.: 12/939,343

(22) Filed: Nov. 4, 2010

(51) Int. Cl. H02K 9/06; H02K 5/22

(52) U.S. Cl. 310/63; 310/68 D

(57) ABSTRACT

An electric machine system including an alternating current (AC) electric machine having a machine housing, and a plurality of switch members arranged within a switch housing. The plurality of switch members are electrically connected to the AC electric machine. A direct current (DC) power source is electrically connected to the plurality of switch members. The DC power source generates a DC current. A controller is arranged within a control housing that is remote from the switch housing. The controller is electrically connected to the plurality of switch members and is configured and disposed to selectively activate select ones of the plurality of switch members in order to convert the DC current between the DC power source and an alternating current (AC) to operate the AC electric machine.

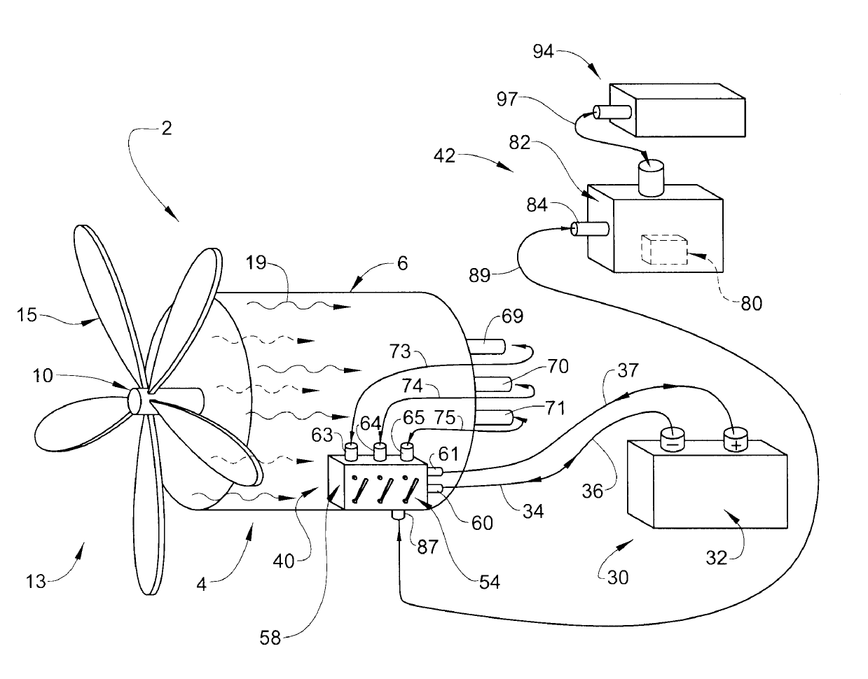

### BACKGROUND OF THE INVENTION

Exemplary embodiments pertain to the art of electric machines and, more particularly, to an inverter for an electric machine.

Conventional electric motor systems, such as those used in automotive, agricultural, and other heavy duty applications where electric and hybrid motors are employed, include an electric motor operatively coupled to an inverter through high voltage cabling. A typical inverter includes a controller portion and a multi-phase power switching portion. The multi-phase power switching portion includes various high voltage components such as insulated gate bipolar transistors (IGBTs), metal oxide semiconductor field effect transistors (mosfets), rectifiers, capacitors, inductors, high voltage wiring and the like. The inverter is electrically connected to an engine control module, a high voltage battery, and the electric motor. The connections between the inverter and the battery, and the inverter and the electric motor, require high voltage cabling. In addition, the heat generated by operation of the high voltage components requires cooling. As such, conventional inverters are also typically connected to a cooling system. Cooling systems for inverters include a fluid coolant such as oil, water, air or other media that can absorb and retain heat.

### BRIEF DESCRIPTION OF THE INVENTION

Disclosed is an electric machine system including an alternating current (AC) electric machine having a machine housing, and a plurality of switch members arranged within a switch housing. The plurality of switch members are electrically connected to the AC electric machine. A direct current (DC) power source is electrically connected to the plurality of switch members. The DC power source generates a DC current. A controller is arranged within a control housing that is remote from the switch housing. The controller is electrically connected to the plurality of switch members and is configured and disposed to selectively activate select ones of the plurality of switch members in order to convert the DC current between the DC power source and an alternating current (AC) to operate the AC electric machine.

Also disclosed is a method of operating an electric machine. The method includes passing a direct current to a plurality of switch members arranged in a switch housing. The plurality of switch members are electrically connected to an alternating current (AC) electric machine. A control signal is directed through a control line electrically connecting the plurality of switch members with a controller arranged in a remotely located control housing. Select ones of the plurality of switch members are selectively activated to convert the direct current to an alternating current based on the control signal the controller, and the alternating current is passed between the plurality of switch members and the AC electric machine.

Further disclosed is an inverter system for operating an alternating current (AC) electric machine with a direct current voltage source. The inverter system includes a plurality of switch members arranged within a switch housing and a controller arranged within a control housing that is remote from the switch housing. The controller is electrically connected to the plurality of switch members and is configured and disposed to selectively activate select ones of the plurality of switch members in order to convert the DC current between the DC power source and an alternating current (AC) to operate an AC electric machine.

### BRIEF DESCRIPTION OF THE DRAWINGS

The following descriptions should not be considered limiting in any way. With reference to the accompanying drawings, like elements are numbered alike:

The figure is a graphical representation of an electric machine system in accordance with an exemplary embodiment.

### DETAILED DESCRIPTION OF THE INVENTION

A detailed description of one or more embodiments of the disclosed apparatus and method are presented herein by way of exemplification and not limitation with reference to the Figure.

Referencing the figure, an electric machine system in accordance with an exemplary embodiment is indicated generally at 2. Electric machine system 2 includes an alternating current (AC) electric machine shown in the form of an electric motor 4. AC electric motor 4 includes a machine housing 6 within which are arranged a stator (not shown) and a rotor (also not shown) that is operatively coupled to a shaft 10. Shaft 10 extends from machine housing 6 and is connected to a cooling system 13. In the exemplary embodiment shown, cooling system 13 includes a fan 15 that delivers a coolant 19 in the form of air currents over and through machine housing 6. Of course it should be understood that the particular type and operation of cooling system 13 can vary. For example, it should be understood that cooling system may be independent from shaft 10. It should also be understood that the particular type of coolant can also vary and may include both gaseous and liquid cooling mediums. For example, cooling system 13 could be configured to deliver a liquid coolant such as water, glycol and the like through machine housing 6. At this point, it should be understood that the electric machine in accordance with the exemplary embodiment could take the form of an electric motor, i.e., an electric machine provided with an electric current input to produce a mechanical output or an electric generator, i.e., an electric machine provided with a mechanical input that is transformed into an electrical current.

In accordance with the exemplary embodiment, AC electric motor 4 is powered by a direct current (DC) power supply 30. DC power supply 30 takes the form of a high voltage battery 32, having a voltage rating above about 100 volts, that delivers a DC current 34 to AC electric motor 4. More specifically, battery 30 is electrically connected to AC electric motor 4 through a first or negative cable 36 and a second or positive cable 37. First and second cables 36 and 37 are high voltage cables that are rated to carry high voltage and high currents. “High voltage” should be understood to mean any voltage shared between electric AC motor 4 and a power supply. In accordance with one exemplary aspect, “high voltage” is voltage in a range of between about 100 volts to about 1000 volts. Voltage should be understood to include voltage passed through negative cable 36 and positive cable 37 to the electric machine when operated in a motor mode or passed from the electric machine through negative cable 36 and positive cable 37 when operated in a generator mode. In general, voltage should be understood to include energy that is exchanged between the electric machine and DC power supply 30 resulting in a transformation of energy between a mechanical and electrical state. In order to operate AC electric motor 4 on DC current 34, electric machine system 2 includes an inverter system having a switch portion 40 and a controller portion 42. In accordance with the exemplary embodiment, switch portion 40 and controller portion 42 are two distinct components located remotely one from the other.

In the exemplary embodiment shown, switch portion 40 includes a plurality of switch members 54 arranged within a switch housing 58. In accordance with one aspect of the exemplary embodiment, switch members 54 constitute insulated gate bipolar transistors (IGBTs), metal oxide semiconductor field effect transistors (mosfets), rectifiers, capacitors, inductors and the like. Switch housing 58 is shown positioned at AC electric motor 4. In the embodiment shown, switch housing 58 is mounted to machine housing 6 so as to be exposed to coolant 19. Although shown sharing common surfaces, it should be understood that switch housing 58 could be arranged within motor hosing 6 without sharing any common surfaces. In this manner, cooling system 13 not only provides coolant for AC electric motor 4 but also cools the plurality of switch members 54. That is, during operation, particularly with high voltages and rapid switch changes, the plurality of switches 54 generate a heat load that should be dissipated in order to prolong service life. As such, switch portion 40 includes a high cooling demand that may be satisfied by cooling system 13. By using the same coolant to cool AC electric motor 4 and the plurality of switches 54 ensures that all high voltage cooling is localized. More specifically, given that the “high voltage” systems typically generate more heat than “low voltage” systems, localized high voltage cooling isolates “low voltage” components from unnecessary heat exposure. “Low voltage” should be understood to mean voltage shared between controller portion 42 and switch portion 40 employed to achieve a change in state, e.g., open/close, switch members 54. In accordance with one aspect of the exemplary embodiment, “low voltage” constitutes voltage in a range of between greater than about 0 volts and about 99 volts. In addition, it should be understood that cooling system 13 could also be configured to deliver a liquid coolant such as water or glycol through machine housing 6 and in proximity to switch housing 58 to reduce temperatures of the plurality of switch members 54.

As further shown in the figure, switch housing 58 includes first and second input terminals 60 and 61 that electrically couple switch members 54 and battery 32 through first and second cables 36 and 37. Switch housing 58 is also shown to include a plurality of output terminals 63-65 that deliver a multi-phase AC current to AC electric motor 4. That is, AC electric motor 4 is a multi-phase electric motor having a plurality of power terminals 69-71. Power terminals 69-71 are electrically connected to output terminals 63-65 through a plurality of cables 73-75. In manner similar to that described above, cables 73-75 are high voltage cables that are rated to carry high voltage and high current in the order of above about 100 volts. With this arrangement, select ones of the plurality of switch members 58 are selectively activated (opened and closed) to convert DC current 34 to a multi-phase AC current that is passed to AC electric motor 4.

In further accordance with the exemplary embodiment, the plurality of switch members 58 are selectively activated by controller portion 42. Controller portion 42 includes a controller 80, such as a central processor unit (CPU), programmable logic controller (PLC) or the like, arranged within a control housing 82 that is distinct from switch housing 58. Control housing 82 includes a control terminal 84 that is electrically connected to a control terminal member 87 on switch housing 58 through a control cable 89. As controller 80 is not required to pass high voltage or high current control signals to switch portion 40, control cable 89 is a low voltage cable. By lower voltages, it should be understood that controller 80 operates on voltages between greater than about 0 volts and about 99 volts. By operating on lower voltages, controller portion 42 has a reduced or lower cooling demand. Electric machine system 2 is also shown to include a motor control module 94 electrically coupled to controller 80 through a motor control cable 97. Motor control module 94 signals controller 80 to operate AC electric motor 4 at a desired condition, such as torque, speed, power and the like depending upon desired operating requirements. In addition to speed control, motor control module 94 also provides other signals, such as various system status signals to controller 80.

At this point it should be understood that the exemplary embodiments provide an electric machine system having separate inverter components. The switch or high voltage portion of the inverter system is located at the electric motor and the controller portion of the inverter system is located remote from the electric motor. Given that the controller portion has a significantly lower cooling requirement than that of the switch portion, the control housing may be located remotely from the switch housing. More specifically, in an automobile application for example, the switch housing may be mounted to the machine housing so as to be actively cooled and the control housing may be mounted to a firewall, or in occupant spaces such as under a dashboard and provided with passive cooling such as heat sinks, vents and the like. It should also be understood that while shown in connection with a multi-phase electric motor, the exemplary embodiments may also be employed with single phase AC electric motors.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. An electric machine system comprising:
an alternating current (AC) electric machine including a machine housing;
a plurality of switch members arranged within a switch housing, the plurality of switch members being electrically connected to the AC electric machine;
a direct current (DC) power source electrically connected to the plurality of switch members, the DC power source generating a DC current; and
a controller arranged within a control housing that is remote from the switch housing, the controller being electrically connected to the plurality of switch members, the controller being configured and disposed to selectively activate select ones of the plurality of switch members in order to convert the DC current between the DC power source and an alternating current (AC) to operate the AC electric machine.

2. The electric machine system of claim 1, wherein the AC electric machine is a multi-phase electric motor, the controller being configured and disposed to electrically activate the plurality of switch members to convert the DC current between the DC power source and a multi-phase AC current to operate the multi-phase electric motor.

3. The electric machine system according to claim 1, wherein the switch housing is arranged adjacent to the machine housing.

4. The electric machine system according to claim 3, wherein the switch housing is arranged upon the machine housing.

5. The electric machine system of claim 3, further comprising: a cooling system configured and disposed to deliver a coolant to the switch housing and the machine housing.

6. The electric machine system of claim 5, wherein the cooling system is a fan mounted to the AC electric machine.

7. The electric machine system of claim 6, wherein the coolant is an airflow developed by the fan.

8. The electric machine system of claim 1, wherein the DC power source is a battery.

9. The electric machine system of claim 8, wherein the battery is at least a 100 volt battery.

10. The electric machine system of claim 1, further comprising: a motor control module electrically coupled to the controller, the motor control module being configured and disposed to signal the controller to selectively activate the plurality of switch members.

11. A method of operating an electric machine, the method comprising:
passing a direct current to a plurality of switch members arranged in a switch housing, the plurality of switch members being electrically connected to an alternating current (AC) electric machine;
directing a control signal through a control line electrically connecting the plurality of switch members with a controller arranged in a remotely located control housing;
selectively activating select ones of the plurality of switch members to convert the direct current to an alternating current based on the control signal from the controller; and
passing the alternating current between the plurality of switch members and the AC electric machine.

12. The method of claim 11, further comprising: delivering a coolant over the alternating current electric machine and the switch housing.

13. The method of claim 12, wherein delivering a coolant over the AC electric machine comprises passing an airflow over the AC electric machine and the switch housing.

14. The method of claim 11, wherein selectively activating the select ones of the plurality of switch members to convert the direct current to an alternating current includes activating the select ones of the plurality of switch members to convert the direct current into a multi-phase alternating current.

15. An inverter system for operating an alternating current (AC) electric machine with a direct current voltage source comprising:
a plurality of switch members arranged within a switch housing; and
a controller arranged within a control housing that is remote from the switch housing, the controller being electrically connected to the plurality of switch members, the controller being configured and disposed to selectively activate select ones of the plurality of switch members in order to convert the DC current between the DC power source and an alternating current (AC) to operate an AC electric machine.

16. The inverter system of claim 15, wherein the controller is configured and disposed to electrically activate the plurality of switch members to convert the DC current between the DC power source and a multi-phase AC current.

17. The inverter system of claim 15, further comprising: a cooling system configured and disposed to deliver a coolant to the switch housing.

18. The inverter system of claim 17, wherein the cooling system is a fan mounted to the AC electric machine.

19. The inverter system of claim 18, wherein the coolant is an airflow developed by the fan.

20. The inverter system of claim 15, wherein the DC power source is a battery.
